(19) United States
(12) Patent Application Publication
(10) Pub. No.: US 2005/0153110 A1
(43) Pub. Date: Jul. 14, 2005

(54) Multi-layer composites and sheet labels

(76) Inventors: Anita B. Juby, Garfield Heights, OH (US); Steve Saunders, Aurora, OH (US)

Correspondence Address: RENNER, OTTO, BOISSELLE & SKLAP, LLP, 1621 EUCLID AVE, 19TH FL, CLEVELAND, OH, 44115-2191, US

(21) Appl. No.: 11/031,537

(22) Filed: Jan. 7, 2005

Related U.S. Application Data
(60) Provisional application No. 60/535,602, filed on Jan. 8, 2004.

(51) Int. Cl. C08J 3/00

(52) U.S. Cl. 428/195.1

(57) ABSTRACT

A composite including (A) a first layer of paper having a printable upper surface and a lower surface, the printable upper surface forming a topmost surface of the composite; (B) a first extruded polymer layer having an upper surface joined to the lower surface of the first layer of paper and having a lower surface; and (C) an adhesive layer on the lower surface of the polymer layer. The composite may further include (D) a release-coated liner having a topmost surface and a bottommost surface and including a second layer of paper and the lower surface of the second layer of paper forms the bottommost surface of the release-coated liner. The release-coated liner may include an additional polymer layer. One or more primer layers may be included between various layers of the composite. The bottom surface of the composite may be printable.

### CROSS-REFERENCE TO RELATED APPLICATION

This application claims the benefit, under 35 U.S.C. §119(e) of U.S. Provisional Application No. 60/535,602, filed 9 Jan. 2004, the entirety of which is incorporated herein by reference.

### TECHNICAL FIELD

This invention relates to composite materials. More particularly, the invention relates to composite multi-layer composite materials suitable for use, for example, as the laser-printable face of adhesive sheet labels, decals and tapes.

### BACKGROUND OF THE INVENTION

Articles such as decals, labels, tapes, etc., which employ an adhesive-backed printed or printable surface have been in general use for many years. The basic construction of a decal or sheet label comprises (1) a face, (2) a liner or backing material, and (3) a layer of adhesive between the face and the liner. Because the surface of the liner which is in contact with the pressure-sensitive adhesive is coated with a release agent, the strength of the adhesive bond to the face is greater than to the liner. Thus, when the liner is peeled from the face, the pressure-sensitive adhesive remains attached to the back of the face.

The portion of the article which remains after the liner has been removed from the pressure-sensitive adhesive backing is the desired pressure-sensitive adhesive-backed label, tape or decal which generally comprises a multi-layer face and the pressure-sensitive adhesive. In some instances, prior art labels and the release liners used therewith have been made from paper or from a material such as polyvinyl chloride, with the label and release liner being made of the same or different materials.

One of the advantages of pressure-sensitive adhesive-coated labels with release liners is that information can be printed on the label prior to attaching the label to another article such as a package, a shelf, etc. It is desirable that such information can be recorded on such labels utilizing various printer types or copying machines. Therefore, the labels and release liners should be able to withstand the conditions of the printers and/or copying machines used, such as elevated temperatures, pressures, solvents, carriers, etc. to which they may be exposed during use. For example, in many instances, attempts to print labels utilizing laser printers and photocopiers result in unacceptable curling of the label due at least in part to the high temperatures to which the label is subjected during the printing process. Similarly, solvents, including water, used in other types of printing can result in curling of the label. Curling of the label is undesirable because the curled labels may jam in the printer and/or the desired printed image will be fuzzy or uneven and unacceptable.

Removability is a desirable feature in many labels. In order to be removable, a label needs to have a suitable combination of facestock strength and adhesive composition, so that the label can be removed with little or no damage to the facesock, e.g., in one piece (or in some cases in a small number of pieces) and without damaging the substrate, and without leaving adhesive residues on, the substrate from which the label is removed. However, in many prior art labels one or both of these elements is missing, resulting in labels that are difficult or impossible to remove cleanly and easily. Another desirable feature in some labels is repositionability, the ability to remove the label from its initial point of adhesion on the substrate and then reapply it to a different location on the same or a different substrate, without damaging either the substrate, the label or the adhesive layer.

Depending on the choice of label facestock to which they are applied, and the substrate(s) to which they are applied, adhesives, and the label facestock carrying the adhesive, may be classified as more or less “permanent,” “removable,” or “repositionable.” When a permanent adhesive label is adhered to a substrate, the adhesive bond to the substrate grows over time, and the label generally cannot be removed without damaging the facestock and/or the substrate, and/or without leaving an adhesive residue on the substrate. In contrast, a removable adhesive label can be removed from a substrate by application of a relatively small peel force with little or no damage to the tape or label and with leaving substantially no adhesive residue on the substrate, and while still having sufficient adhesion to be reapplied to the same or similar substrate. Such removal can be accomplished even after an extended period of time, because adhesion to the substrate remains constant, or grows only slightly over time,. When a repositionable adhesive label is adhered to a substrate, the adhesive bond is at least initially weak enough to allow removal for repositioning of the label. A repositionable adhesive label may remain removable, e.g., for repositioning, or may develop into a substantially permanent adhesive.

Various attempts have been made to eliminate or reduce curling in adhesive-backed labels by using various materials and combinations of materials in the face and release liners. However, various problems remain. For example, polymer film-covered materials have a tendency to acquire a static electric charge which prevents the labels from feeding smoothly into printers and copying machines. In addition, polymer films may be adversely affected by the heat of printers and copiers. For example, the polymer film may be softened by the heat, and the laminate when printed may curl as a result of differential thermal expansion. Therefore, a need remains for such a laminate which is both printable and free of the adverse affects found in prior art materials, and a need remains for a label which is cleanly and easily removable, and/or removable and repositionable.

### SUMMARY

A composite suitable for preparing labels is described.

A composite, in one embodiment in accordance with the present invention, includes (A) a first layer of paper having a printable upper surface and a lower surface, the printable upper surface forming a topmost surface of the composite; (B) a first extruded polymer layer having an upper surface joined to the lower surface of the first layer of paper and having a lower surface; and (C) an adhesive layer on the lower surface of the first extruded polymer layer. In one embodiment, the composite further includes (D) a release-coated liner having a topmost surface and a bottommost surface and comprising a second layer of paper or a second polymer layer having an upper surface and a lower surface and a release coating having an upper surface and a lower surface, in which the upper surface of the release coating forms the topmost surface of the release-coated liner and is in contact with the adhesive layer, and the lower surface of the second layer of paper or second polymer layer forms the bottommost surface of the release-coated liner.

A composite in another embodiment in accordance with the present invention, includes:
(A) a first layer of paper having a printable upper surface and a lower surface, the printable upper surface forming a topmost surface of the composite;
(B) an extruded polyolefin layer having an upper surface joined to the lower surface of the first layer of paper and having a lower surface;
(C) an adhesive on the lower surface of the extruded polyolefin layer; and
(D) a release-coated liner having a topmost surface and a bottommost surface and comprising a second layer of paper having an upper surface and a lower surface, a second polyolefin layer having an upper surface and a lower surface and a release coating having an upper surface and a lower surface, wherein the upper surface of the release coating forms the topmost surface of the release-coated liner and is in contact with the adhesive layer, the upper surface of the second polyolefin layer is joined to the lower surface of the release coating, and the lower surface of the second polyolefin layer is joined to the upper surface of the second layer of paper, and the lower surface of the second layer of paper forms the bottommost surface of the release-coated liner.

A composite in a further embodiment in accordance with the present invention includes:
(A) a first layer of paper having a printable upper surface and a lower surface, the printable upper surface forming a topmost surface of the composite;
(B) an extruded polyolefin layer having an upper surface joined to the lower surface of the first layer of paper and having a lower surface;
(C) an adhesive on the lower surface of the extruded polyolefin layer;
(D) a release-coated liner having a topmost surface and a bottommost surface and comprising a second layer of paper having an upper surface and a lower surface, a second extruded polyolefin layer having an upper surface and a lower surface and a release coating having an upper surface and a lower surface, wherein the upper surface of the release coating forms the topmost surface of the release-coated liner and is in contact with the adhesive layer, the upper surface of the second extruded polyolefin layer is joined to the lower surface of the release coating, and the lower surface of the second extruded polyolefin layer is joined to the upper surface of the second layer of paper, and the lower surface of the second layer of paper forms the bottommost surface of the release-coated liner; and
at least two primer layers, at least on each between the first layer of paper and the first extruded polyolefin layer, and/or between the first extruded polyolefin layer and the adhesive layer, and/or between the second extruded polyolefin layer and the second paper layer.

The composites in accordance with the present invention may be used as the face of other composites such as labels, tapes, etc. These composites exhibit film-like strength and paper-like performance. Thus, in some embodiments, the composites, when formed into a label, are cleanly removable without damaging or breaking away of the label materials. When matched with a complementary release liner, the resulting composite resists curling when exposed to the extremes of temperature and moisture, and the exposed upper and lower surfaces of the composites can be imprinted by means of laser printers or copying machines with or without the application of primers, inks and over-varnishes required of many prior art laminates. In addition, the exposed upper and lower surfaces of the composites can be imprinted by other printing methods, including but not limited to, screen printing, ink-jet printing, flexo printing, gravure printing, thermal transfer printing, direct thermal printing and offset printing. In addition, in some embodiments, the symmetrical construction helps prevent curling of the composite. The polymeric layers provide enhanced strength to the composites of the present invention, assisting in improving the removability of labels made from the composites.

### BRIEF DESCRIPTION OF THE DRAWINGS

FIG. 1 is a cross-section of a composite in accordance with the present invention which comprises three layers.

FIG. 2 is a cross-section of another composite in accordance with the present invention which comprises five layers.

FIG. 3 is a cross-section of another composite in accordance with the present invention which comprises six layers.

FIG. 4 is a cross-section of another composite, similar to the composite of FIG. 2, but also including a primer layer, in accordance with the present invention.

FIGS. 5-8 are cross-sectional views of additional embodiments of composites in accordance with the present invention, similar to the embodiment of FIG. 3, but also including at least one primer layer.

It should be appreciated that for simplicity and clarity of illustration, elements shown in the Figures have not necessarily been drawn to scale. For example, the dimensions of some of the elements may be exaggerated relative to each other for clarity. Further, where considered appropriate, reference numerals have been repeated among the Figures to indicate corresponding elements.

It should be appreciated that the process steps and structures described below do not form a complete process flow for preparing a composite for end use as a label, decal, etc. The present invention can be practiced in conjunction with techniques currently used in the art, and only so much of the commonly practiced process steps are included as are necessary for an understanding of the present invention.

### DETAILED DESCRIPTION

The composites of the present invention include, as one layer (A), a substrate layer of paper. In one embodiment, the layer of paper is provided in sheet form. Paper substrates are particularly useful because of the wide variety of applications in which they can be employed. Any type of paper having sufficient tensile strength to be handled in conventional paper coating and treating apparatus can be employed as the substrate layer. The type of paper used depends upon the end use and particular personal preferences. Included among the types of paper which can be used is paper, clay coated paper, glassine, polymer coated paper, paperboard from straw, bark, wood, cotton, flax, cornstalks, sugarcane, bagasse, bamboo, hemp, and similar cellulose materials prepared by such processes as the soda, sulfite or sulfate (Kraft) processes, the neutral sulfide cooking process, alkali-chlorine processes, nitric acid processes, semi-chemical processes, etc. Although paper of any weight can be employed as a substrate material, paper having weights in the range of from about 20 to about 250 pounds per ream are most useful, and in one embodiment, papers having weights in the range of from about 40 to about 70 pounds per ream may be used. The term “ream” as used herein equals 3000 square feet (278.7 square meters). Examples of specific papers which can be utilized as substrates in preparing the deposit composites of the present invention include 41-pound offset grade bleached Kraft; 50-pound bleached Kraft paper, etc.

Here, as elsewhere throughout the specification and claims, the numerical limits of the ranges and ratios disclosed and claimed herein may be combined, and the disclosure of specific ranges and ratios is considered to include such additional limits and ranges and intervening limits and ranges.

In one embodiment, the exposed upper and/or lower surfaces of the composite may comprise a thin layer (e.g., from about 1 to about 3 μm) of printable material other than paper, such as, for example, acetate or polyester. Thus, in such an embodiment, the first layer of paper is replaced by the printable material other than paper. This structure allows the benefits of the printable material to be obtained without the cost of a thicker layer of the printable material.

In accordance with the invention, the substrate layer of paper is printable. In one embodiment, the substrate layer of paper (A) is treated to improve its printability. Many such treatments are known to those of ordinary skill in the art and may be suitably selected based upon, e.g., the type of paper and the type of printing to be applied to the paper. For example, the paper may be corona treated, or a sizing or pigment-containing material or coating may be applied.

The composites of the present invention comprise (B) a first extruded polymer layer having its upper surface bonded to the lower surface of the substrate layer (A). In this embodiment, the lower surface of the extruded polymer film (B) is free of any release coatings. In other embodiments, the composite of the present invention comprises a second polymer layer or a second polyolefin layer, which may be extruded. The following disclosure relating to the extruded polymer or polyolefin layer is broadly applicable to any of the extruded polymeric layers of the present invention. Any of the polymers described below may be independently selected for use in both the polymer layers.

In one embodiment, the extruded polymer layer may comprise polymers and copolymers of monoolefins having from, for example, 2 to about 12 carbon atoms, in one embodiment, 2 to 8 carbon atoms. In one embodiment, the polymer is an α-olefin having from 2 to 4 carbon atoms per molecule. Examples of said homopolymers include polyethylene, polypropylene, poly-1-butene, etc. An example of a copolymer within the above definition is a copolymer of ethylene with 1-butene having from 1 to about 10, and in one embodiment, from 1 to 5 and in another embodiment from 1 to 3 weight percent of the 1-butene comonomer incorporated into the copolymer molecule. Blends of copolymers with polyisobutylene also are useful, and examples of such blends include those blends containing up to about 35 weight percent, in one embodiment from 1 to 35 weight percent of polyisobutylene and from 99 to 65 weight percent of a copolymer of ethylene, another comonomer such as 1-butene. In one embodiment, the polymer comprises a polyethylene or polypropylene. In one embodiment, the polyethylene may be one or more of low- medium- or high-density polyethylene. The low density range is from about 0.910 to about 0.925; the medium density polyethylene is from about 0.925 to about 0.940; and the high density polyethylene is characterized as having a density of 0.940 to about 0.965. These three density ranges are sometimes referred to as types I, II and III, respectively.

In one embodiment, the extruded polymer or polyolefin layer is a high-density polyethylene. In one embodiment, the extruded polymer or polyolefin layer is a medium-density polyethylene. In one embodiment, the extruded polymer or polyolefin layer is a low-density polyethylene. In one embodiment, the extruded polymer or polyolefin layer is a polypropylene. In one embodiment, the extruded polymer or polyolefin layer may comprise a blend or mixture of one of the foregoing materials. The extruded polymer layer may have a gloss or matte finish.

In one embodiment, the extruded polymer layer is extrusion-coated onto the paper substrate (A) at extrusion temperatures, for example, within in the range of from about 210° C. to about 270° C. using any standard extrusion process known to the art. The process is conveniently carried out in a continuous manner, and the weight of the first extruded polymer layer applied to the paper substrate will usually be within the range of from about 3 to about 30, and in one embodiment, from about 5 to about 20 pounds per ream. In one embodiment, the first extruded polymer layer is applied at from about 11 to about 15 pounds per ream, and in another from about 10 to about 13 pounds per ream, and in one from about 11 to about 13 pounds per ream. For example, in one embodiment, the first extruded polymer layer may be a high-density of polyethylene applied at from about 10 to about 20 pounds per ream, and in another embodiment, the first extruded polymer layer may comprise a linear low-density polyethylene applied at about 10 to about 20 pounds per ream.

In one embodiment, the extruded polymer layer is free of any orientation. In another embodiment, the extruded polymer layer is not biaxially oriented. In another embodiment, the extruded polymer layer has some orientation in the machine direction, i.e., the direction in which the paper layer is moved during the extrusion process. This degree of orientation obtained in the extrusion process, when present, is substantially less than the orientation obtained by machine-direction stretching of polymer films by the conventional methods known in the art. In one embodiment, any orientation in the extruded polymer or polyolefin layer is an artifact of the extrusion process, and is not purposely applied to the extruded polymer layer.

In one embodiment, the extruded polymer layer is not cleanly separable from the first layer of paper. Thus, the extruded polymer layer is joined to the paper sufficiently strongly that it cannot be cleanly separated from the paper, without damage to either or both of the extruded polymer layer or the paper. In another embodiment, the extruded polymer layer is permanently adhered to the first layer of paper. In this embodiment, the extruded polymer layer cannot be separated from the paper without destruction or delamination of the paper. Similarly, in an embodiment in which the release-coated liner includes a second polymer layer, in one embodiment the second polymer layer is not cleanly separable from the second layer of paper, and in one embodiment, the second polymer layer is permanently adhered to the second layer of paper.

In one embodiment, the first layer of paper having a printable upper surface is subjected to a high-energy electrical discharge (or plasma) such as the high-energy electrical discharges produced by corona discharge and glow discharge which are well known in the industry. Corona discharge is a high-energy, high-ionizing discharge which is produced at electrodes when a high-voltage is applied across the plates of a condenser (capacitor). The corona discharge treatment improves the surface energy of the upper surface of the paper and improves the printability of the surface. either or both major surfaces of the first layer of paper (and of the second layer of paper in appropriate embodiments) may be corona treated.

In one embodiment, the composite of the invention is prepared by applying the first extruded polymer layer (B) on a substrate layer of paper and treating the lower surface of the first extruded polymer layer with a corona discharge prior to applying an adhesive layer thereto. As disclosed in more detail below, a primer layer may be applied to the lower surface of the extruded polymer layer instead of or in addition to the foregoing corona or other treatment. In addition, in other embodiments, a primer layer may be applied to the lower surface of the first layer of paper, to the upper surface of the second layer of paper, and in two or more such positions, instead of or in addition to a corona or other treatment. In one embodiment, at least one primer layer between at least one of the first layer of paper and the first extruded polymer layer, the first extruded polymer layer and the adhesive layer, and the second polymer layer and the second paper layer. In one embodiment, a primer layer is in each one of these locations. Although not shown, a primer layer may also be located between the release liner and the layer upon which it is deposited, either the second paper layer or the second polymer layer.

In one embodiment, the first layer of paper and the polymer or polyolefin, with or without an intervening primer layer, and the second layer of paper and the second polymer or polyolefin, may be obtained and used as a pre-formed facestock unit. Examples of such products include a variety of facestocks available from various vendors. One such vendor is Loparex Inc., Willowbrook, Ill. Loparex provides various grades of facestock, with and without primer layers, suitable for use in forming layers (A) and (B), and for use in embodiments including the liner (D), in accordance with the present invention. Several LOPAREX® facestocks are identified in the Examples.

In one embodiment of the present invention, the composite comprises (A) a first layer of paper having a printable upper surface and a lower surface, the printable upper surface forming a topmost surface of the composite; (B) a first extruded polymer layer having an upper surface joined to the lower surface of the first layer of paper and having a lower surface; and (C) an adhesive layer on the lower surface of the polymer layer. This type of composite is useful particularly as the face portion of a sheet label, tape, etc.

Any adhesive composition known in the art, including pressure-sensitive adhesives, can be applied to the composite of the present invention. Such adhesive compositions are described in, for example, “Adhesion and Bonding,” Encyclopedia of Polymer Science and Engineering, Vol. 1, pp. 476-546, Interscience Publishers, Second Ed., 1985. Such compositions generally contain an adhesive polymer such as natural or reclaimed rubbers, styrene-butadiene rubber, styrene-butadiene or styrene-isoprene block copolymers, polyisobutylene, poly(vinylether) or poly(acrylic)ester as a major constituent. Other materials may be included in the adhesive composition such as resin tackifiers including rosin esters, oil-soluble phenolics and polyterpenes; antioxidants; plasticizers such as mineral oil or liquid polyisobutylene; and fillers such as zinc oxide or hydrated alumina. The selection of the adhesive to be used in any composites of the invention may be suitably selected by those skilled in the art familiar with many suitable adhesives available for particular applications. In one embodiment, the adhesive is a pressure-sensitive adhesive.

The layer of adhesive can be applied by techniques known to those skilled in this art and at coating weights between about 1 and 100 gram per square meter (g/m²). If desired, the first extruded polymer layer can be activated prior to application of the layer of adhesive to improve the bond between the polymer and adhesive layers. The surface of the first extruded polymer layer can be activated by treatments such as flame oxidation; chemical oxidation; treatment with a variety of agents such as ozone, chlorine and various acids; various forms of electrical bombardment or discharge treatments such as corona discharge, glow discharge, etc., using readily available equipment and known techniques.

In one embodiment, a primer layer is applied between adjacent layers of the composite. A primer layer may be applied between the paper and the polymer or polyolefin layer, between the polymer or polyolefin layer and the adhesive layer, and/or between the polymer or polyolefin layer and the release coating. Suitable primers can be selected by those of skill in the art. As is known in the art, primers may be formulated for use with specific materials to be bonded together, such as specific adhesives and specific substrates such as paper, polymeric or other substrates.

In one embodiment, a primer layer is in contact with the lower surface of the extruded polymer layer. The primer layer is thus positioned between the lower surface of the extruded polymer layer and the upper surface of the adjacent pressure-sensitive adhesive. In one embodiment, the use of a soluble or dispersible primer between the lower surface of the extruded polymer layer and the pressure-sensitive adhesive provides improved bonding of the pressure-sensitive adhesive to the extruded polymer layer.

In one embodiment, a primer layer is in contact with the lower surface of the paper layer and with the upper surface of the extruded polymer or polyolefin layer. In one embodiment, a primer layer is in contact with the lower surface of the second polymer layer and with the upper surface of the second layer of paper. In both such embodiments, the primer layer may be the same as or different from the primer layer described above for placement between the lower surface of the extruded polymer layer and the upper surface of the adjacent pressure-sensitive adhesive and as described in more detail in the following disclosure. As described in more detail below, a plurality of such primer layers may be used in any combination.

In one embodiment, the primer is a solvent-soluble, water-soluble or a water dispersible primer. In one embodiment, the primer layer is an adhesion-promoting material and may be made from any radiation-curable, solvent-based or water-based primer designed to increase the adhesion of coatings, and particularly of adhesives, to a polymer substrate, or to increase adhesion between a paper or other substrate to a polymer substrate. In one embodiment, the primer layer is transparent. The primer layer material, in one embodiment, is comprised of a lacquer and a diluent. The lacquer is typically comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof. Examples of the diluents that can be used include water, ethanol, isopropanol, butanol, ethyl acetate, propyl acetate, butyl acetate, toluene, xylene, acetone, methyl ethyl ketone, heptane, and mixtures thereof. The ratio of lacquer to diluent is dependent on the viscosity required for application of the adhesion-promoting layer, the selection of such viscosity being within the skill of the art. Examples of the adhesion-promoting layer materials that can be used include CLB04275F—Prokote Primer (a product of Sun Chemical Corporation identified as a solvent based primer useful with inks and coatings).

In one embodiment, the primer may be a water-soluble polymer including polyacrylic acids, polyacrylates, polyvinyl alcohols, hydroxycellulose, hydroxyalkyl celluloses, polyvinylpyrrolidone, polyethylene oxides, alginates, xanthan gum, polyacrylamides, etc. Specific examples of water-soluble or water dispersible primers include polyvinylpyrrolidone from GAF Corporation, Wayne, N.J., and Pancake Gum; Brownbridge from Kimberly Clark Corp., Troy, Ohio. The amount of primer between the lower surface of the extruded polymer layer and the adhesive layer should be sufficient increase the adhesion between the polymer layer and the adhesive layer to greater than the adhesion between the adhesive layer and the release-coated liner or, in the case of removable adhesives, to greater than the adhesion between the adhesive layer and the substrate to which the label or other device is applied. In one embodiment, the primer may be a water-based emulsion of a polyester polyurethane and an acrylic emulsion, which may be cross-linked with an aziridine or other suitable crosslinker. In one embodiment, the polyester polyurethane is an aliphatic polyester polyurethane. The primer may contain suitable additives, such as a wax and/or silica or other filler.

The primer layer typically has a thickness in the range of about 0.1 to about 6 microns, and in one embodiment up to about 2 microns. Generally a thin layer of primer of a thickness in the range of about 0.2 to about 2 microns, and in one embodiment, from about 0.3 to about 0.8 microns, is effective.

In one embodiment, the primer layer may be coextruded with the extruded polymer layer. In another embodiment, the primer layer is separately applied, for example by roll coating or by doctor blade coating. In a coextrusion embodiment, the uses an extrusion coating station equipped with two extruders. The first extruder is fed an extrudable polymer material as described above. The second extruder is fed a primer coat material; this primer acts as a tie or adhesion promoter between the lower surface of the extruded polymer layer and the adhesive layer.

In one embodiment, a first primer layer is between the first layer of paper and the first extruded polyolefin layer, forming first laminate, a second primer layer is between the second extruded polyolefin layer and the second layer of paper, forming a second laminate, and the first laminate is substantially the same as the second laminate. In one such embodiment, the first and second laminates are substantially identical. In one such embodiment, the first and second laminates are identical, with the only difference being that to one the adhesive is applied and to the other the release material is applied. Such an embodiment provides both the desirable symmetrical orientation of the composite of the present invention and simplifies manufacturing, since only a single laminate need be made, and the laminate thus made can be used for both parts of the composite. That is, in this embodiment, one portion of the laminate is used to form the composite comprising the adhesive layer, and another portion of the laminate is used to form the release-coated liner.

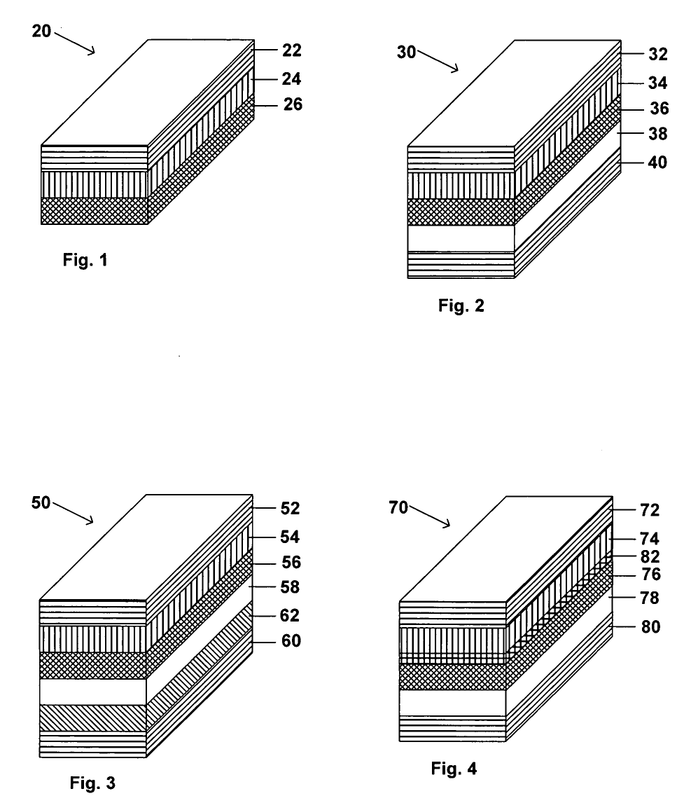

A composite containing a layer of adhesive is illustrated in FIG. 1 in which the composite is generally referred to by reference numeral 20. The composite comprises a substrate layer of paper 22, a first extruded polymer layer 24 joined to the lower surface of the paper substrate 22, and a layer 26 of adhesive which is in contact with and bonded to the lower surface of the first extruded polymer layer 24.

In another embodiment, the composite of the invention described above and illustrated in FIG. 1 is matched with a complementary release liner. In this embodiment, the composite comprises (A) a first layer of paper having a printable upper surface and a lower surface, the printable upper surface forming a topmost surface of the composite; (B) a first extruded polymer layer having an upper surface joined to the lower surface of the first layer of paper and having a lower surface; (C) an adhesive layer on the lower surface of the polymer layer; and (D) a release-coated liner having a topmost surface and a bottommost surface and comprising a second layer of paper having an upper surface and a lower surface and a release coating having an upper surface and a lower surface. Thus, in one embodiment, the composite further includes (D) a release-coated liner having a topmost surface and a bottommost surface and comprising a second layer of paper or a second polymer layer having an upper surface and a lower surface and a release coating having an upper surface and a lower surface, in which the upper surface of the release coating forms the topmost surface of the release-coated liner and is in contact with the adhesive layer, and the lower surface of the second layer of paper or second polymer layer forms the bottommost surface of the release-coated liner.

One such embodiment is illustrated in FIG. 2 wherein the composite is generally referred to by reference numeral 30. The composite comprises a substrate layer of paper 32 having the first extruded polymer layer 34 which is bonded to the lower surface of the substrate 32. A layer 36 comprising an adhesive is in contact with the lower surface of the first extruded polymer layer 34. A coating of release composition 38 is bonded to a second layer of paper material 40, and the upper surface of the release composition also is in contact with the adhesive layer 36.

The release-coated liner is illustrated in FIG. 2, further including (D) a layer of paper material 40 having a release coating 38 on its upper surface in addition to the layers (A), (B) and (C) described above. The release-coated liner may comprise, in addition to the layer of paper material 40, one or more additional layers of any paper material or polymer film.

An embodiment including an additional layer is illustrated in FIG. 3. In FIG. 3 the composite is generally referred to by reference numeral 50. The composite 50 comprises a substrate layer of paper 52 having a first extruded polymer layer 54 which is bonded to the lower surface of the substrate 52. A layer 56 comprising an adhesive is in contact with the lower surface of the first extruded polymer layer 54. A coating of release composition 58 is bonded to a second polymeric layer 62 which is in turn bonded to a layer of paper material 60, and the upper surface of the release composition 58 also is in contact with the adhesive layer 56.

FIG. 4 is a cross-section of another composite, similar to the composite of FIG. 2, but also including a primer layer, in accordance with an embodiment of the present invention. As shown in FIG. 4, in this embodiment, the composite 70 includes a substrate layer of paper 72 having the first extruded polymer layer 74 which is bonded to the lower surface of the substrate 72. In this embodiment, a primer layer 82 is joined to the lower surface of the extruded polymer layer 74. A layer 76 comprising an adhesive is in contact with the lower surface of the primer layer 82. A coating of release composition 78 is bonded to a second layer of paper material 80, and the upper surface of the release composition also is in contact with the adhesive layer 76. The primer layer 82 may include any known primer material, as disclosed herein.

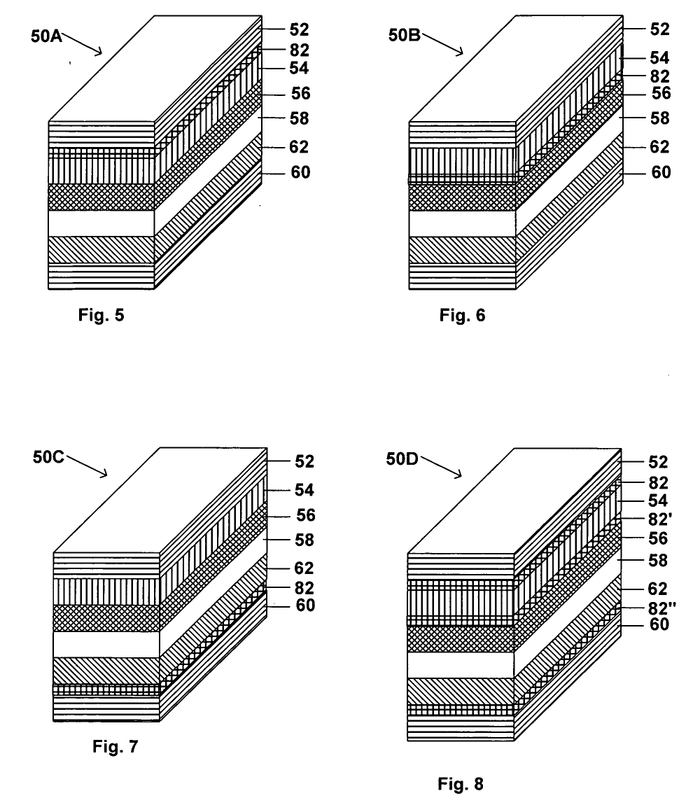

As noted above, in one embodiment, the composite may further include at least one primer layer between at least one of the first layer of paper and the first extruded polymer layer, the first extruded polymer layer and the adhesive layer, and the second polymer layer and the second paper layer. FIGS. 5-8 are cross-sectional views of additional embodiments of composites in accordance with the present invention, similar to the embodiment of FIG. 3, but also including at least one primer layer in each of the above disclosed locations, and in all such locations.

FIG. 5 is a cross-section of another composite 50A, similar to the composite 50 of FIG. 3, but also including a primer layer 82, in accordance with an embodiment of the present invention. As shown in FIG. 5, in this embodiment, the composite 50A includes a substrate layer of paper 52 having the primer layer 82 disposed between the paper layer 52 and the first extruded polymer layer 54. In this embodiment, the primer layer 82 is joined to the lower surface of the paper layer 52 and to the upper surface of the extruded polymer layer 54. The remaining layers are the same as in FIG. 3. The primer layer 82 independently may include any known primer material, as disclosed herein.

FIG. 6 is a cross-section of another composite 50B, similar to the composite 50 of FIG. 3, but also including a primer layer 82, in accordance with another embodiment of the present invention. As shown in FIG. 6, in this embodiment, the composite 50B includes a substrate layer of paper 52 having the first extruded polymer layer 54 which is bonded to the lower surface of the substrate 52. In this embodiment, a primer layer 82 is joined to the lower surface of the extruded polymer layer 54. A layer 56 comprising an adhesive is in contact with the lower surface of the primer layer 82. A coating of release composition 58 is bonded to a second polymer layer 62, which is in turn joined to a second layer of paper material 60, and the upper surface of the release coating also is in contact with the adhesive layer 56. The primer layer 82 independently may include any known primer material, as disclosed herein.

FIG. 7 is a cross-section of another composite 50C, similar to the composite 50 of FIG. 3, but also including a primer layer 82, in accordance with another embodiment of the present invention. As shown in FIG. 7, in this embodiment, the composite 50C includes a substrate layer of paper 52 having the first extruded polymer layer 54 which is bonded to the lower surface of the substrate 52. A layer 56 comprising an adhesive is in contact with the lower surface of the first extruded polymer layer 54. A coating of release composition 58 is bonded to a second polymer layer 62, and the upper surface of the release coating 58 also is in contact with the adhesive layer 56. In this embodiment, a primer layer 82 is joined to the lower surface of the second polymer layer 62 and to the upper surface of the second paper layer 60. The primer layer 82 independently may include any known primer material, as disclosed herein.

FIG. 8 is a cross-section of another composite 50D, similar to the composite 50 of FIG. 3, but also including three primer layers 82, 82′ and 82″, in accordance with an embodiment of the present invention. As shown in FIG. 8, in this embodiment, the composite 50D includes a substrate layer of paper 52 having the primer layer 82 disposed between the paper layer 52 and the first extruded polymer layer 54. In this embodiment, the primer layer 82 is joined to the lower surface of the paper layer 52 and to the upper surface of the extruded polymer layer 54. In this embodiment, a primer layer 82′ is joined to the lower surface of the extruded polymer layer 54. A layer 56 comprising an adhesive is in contact with the lower surface of the primer layer 82′. A coating of release composition 58 is bonded to a second polymer layer 62, and the upper surface of the release coating 58 also is in contact with the adhesive layer 56. In this embodiment, a primer layer 82″ is joined to the lower surface of the second polymer layer 62 and to the upper surface of the second paper layer 60. Each of the primer layers 82, 82′ and 82″ independently may include any known primer material, as disclosed herein. In other embodiments, not shown, the composite may comprise any combination of two of the three primer layers 82, 82′, 82″, at any of the disclosed locations.

In one embodiment, the polymer layer 62 of the release-coated liner (D) is the same as that used as the first extruded polymer layer 54. In one embodiment, the polymer layer 62 of the release-coated liner is an extruded polymer layer, extruded onto the paper layer of the release-coated liner in a manner substantially the same as used for the first extruded polymer layer extrusion onto the first layer of paper.

The layer of paper material 40, 60, 80 may be formed of any of the paper materials disclosed above for use in the upper paper layer 22, 32, 52, 72. In one embodiment, the layer of paper material 40, 60, 80 may be prepared from any fibrous cellulose material, which may be provided in sheet form, made by chemical, mechanical or chemical-mechanical processes. In one embodiment, the layer 40, 60, 80 is made from Kraft paper. The layer 40, 60, 80 also may comprise a film of one or more polymers. The polyolefin film may comprise polymers and copolymers of monoolefins having from, for example, 2 to about 12 carbon atoms, in one embodiment from 2 to 8 carbon atoms. In one embodiment, the polymer is of α-olefins having from 2 to 4 carbon atoms per molecule. Examples of the homopolymers include polyethylene, polypropylene, poly-1-butene, etc. An example of a copolymer within the above definition is a copolymer of ethylene with 1-butene having from 1 to 10, preferably from 1 to 5 and more preferably from 1 to 3 weight percent of the 1-butene comonomer incorporated into the copolymer molecule. Blends of copolymers with polyisobutylene also are useful, and examples of such blends include those blends containing up to about 35 weight percent, in one embodiment from 1 to 35 weight percent of polyisobutylene and from 99 to 65 weight percent of a copolymer of ethylene, another comonomer such as 1-butene. In one embodiment, polyethylene and/or polypropylene are used. The useful polyethylenes include the low density polyethylenes, medium-density polyethylenes, and high density polyethylenes. The selection of a high, medium or low density polyethylene will depend upon the intended application and the types of materials which the surfaces of the polyolefin film will contact in use.

In one embodiment, the second layer of paper (e.g., 40, 60, 80), in the release coated liner, is printable. In one embodiment, the second layer of paper is treated to improve its printability. Many such treatments are known to those of ordinary skill in the art and may be suitably selected based upon, e.g., the type of paper and the type of printing to be applied to the paper. For example, the paper may be corona treated, or a sizing or pigment-containing material or coating may be applied.

Release-coated liners useful in the composites of the present invention may comprise a release-coated composite comprising more than one layer of material including alternating layers of paper and polymer to provide desirable properties. The following examples of composites illustrate, without limitation, these types of composites which may be utilized as the release-coated liners in the composites of the invention:
release composition/polyethylene/paper;
release composition/paper/polyethylene;
release composition/polyvinylchloride/paper;
release composition/polyethylene/paper/polyethylene/tissue; etc.
   In these examples of release-coated liners, the polyethylene films may range from low-density to high-density as described earlier, and the paper materials may be any of the paper materials described earlier with respect to the face portion of the composites.

The release coating on the liner material (for example, release coating 38 on paper layer 40 in FIG. 2 and release coating 58 on polymer layer 62 and paper layer 60 in FIG. 3) provides for easy removal of an adhesive-backed face (such as a label, name-tag, etc.) from the release liner. The release liner permits the adhesive-coated back surface of the label to adhere lightly to the top surface of the release-coated liner but prevents the adhesive on the back of the label from sticking too tightly to the release liner. That is, if the release liner was not coated with some form of release coating, it would be difficult to remove the release liner from the adhesive-backed face without removing some of the adhesive from the face.

The specific release coating used in the composites of the present invention is not critical to the invention. In general, a coating of any release agent can be used, and the suitability of any of the commercially available release coatings can be determined experimentally. In one embodiment, the release coatings include cured silicones (polymethylsiloxanes) and a number of curable silicones are available commercially for this purpose from, for example, the Dow Corning Company and the Goldschmidt Chemical Corp., Hopewell, Va. In one embodiment, the curable silicone is a radiation-curable silicone release composition which is commercially available. In one embodiment, the release coating may be any of the release coatings disclosed in U.S. Pat. No. 6,150,035, the disclosure of which is incorporated by reference herein for its teachings relating to release coatings and suitable compositions which may be used therefor.

In one embodiment, the release coating may be an inherently releasable polymer layer. In one embodiment, the inherently releasable polymer layer comprises polytetrafluoroethylene (PTFE). In one embodiment, the inherently releasable polymer comprises PTFE mixed together with another polymer, such as any of the polymeric materials disclosed herein for use as the polymer layers.

In one embodiment, the release-coated liner may comprise a second polymer layer, in which the polymer layer is a polyolefin layer similar to or the same as the first extruded polymer layer.

In one embodiment, the second polymer layer may be prepared from high-density polyethylene, low-density polyethylene, or medium-density polyethylene, or from polypropylene as disclosed above with respect to the first extruded polymer or polyolefin. In one embodiment, the first extruded and second polymer layers may be derived from polyethylene of the same density (that is, both the first extruded polymer layer and the second polymer may be high-density, medium-density or low-density polyethylene), or in another embodiment, the two layers may be derived from polyethylenes of different densities. Thus, the first extruded polymer layer can be high-density polyethylene and the second polymer layer a low-density polyethylene, or the first extruded polymer layer can be derived from a low-density polyethylene, and the second polymer layer derived from a high-density polyethylene. The selection of the densities of the first extruded and second polymer layers will depend upon the intended application and the desired properties which can be varied by varying the polyethylene densities, or by selection of polypropylene or another suitable polyolefin, such as one of those disclosed above. In one embodiment, both the first extruded polymer layer and the second polymer layer are extruded onto paper substrates.

The composites of the invention can be prepared by procedures well known in the art. In one embodiment the laminates which comprise the face and the release-coated liner are prepared separately. The adhesive is applied to either the back of the face laminate or to the release-coated side of the liner. Generally, the adhesive is applied to the release-coated liner. The face and liner are then brought into contact to form the desired face laminate which may be a sheet label, tape, decal, etc. In another embodiment the adhesive is applied to a face laminate and the various layers of the release-coated liner are applied individually to the adhesive side of the face laminate in forming the composite.

In another embodiment of the composite of the invention which comprises a face, adhesive and liner, the composite is characterized as having a “balanced” or ”symmetrical” construction, in which the outer faces of the composite, that is, both the topmost layer of the label and the bottommost layer of the release liner, comprise paper. In one embodiment, both such paper layers include a polymer layer on the inner (non-exposed) surface. Such balanced or symmetrical composites exhibit improved properties such as improved resistance to curling over a wide range of temperatures and humidities, including very low temperatures, high humidity coupled with elevated temperatures such as those experienced by substrates passing through laser printers and copiers. These composites are considered “balanced” or “symmetrical” because the outermost layers of the face laminate and the liner laminate are of identical construction, and when the composite is prepared with an adhesive, the liner composite is reversed whereby the liner composite is the mirror image of the face composite. The following composite is an example of a composite having a “balanced” or “symmetrical” construction, and the composite comprises the following layers from top to bottom: 41-pound paper/18-pound extruded linear low-density polyethylene/ adhesive/release coating/18-pound extruded linear low-density polyethylene/41-pound paper. Specific examples of such balanced symmetrical construction are found in Examples G-K and R-V.

The following examples illustrate the construction of composites in accordance with some exemplary, but non-limiting, embodiments of this invention. Reference to “pound” refers to number of pounds per ream.

### EXAMPLE A

(A) Substrate: 50-pound bleached Kraft paper.

(B) First extruded polymer layer: 1 8-pound extruded linear extruded low-density polyethylene.

(C) Adhesive: pressure-sensitive adhesive (acrylic terpolymer, about 23 g/m²).

### EXAMPLE B

(A) Substrate: 50-pound bleached Kraft paper.

(B) First extruded polymer layer: 11-pound extruded high-density polyethylene.

(C) Adhesive: pressure-sensitive adhesive (acrylic terpolymer, about 23 g/m²).

### EXAMPLE C

Face:

(A) Substrate: 61-pound bleached Kraft paper.

(B) First extruded polymer layer: 18-pound extruded linear low-density polyethylene.

(C) Adhesive:

Pressure-sensitive adhesive (acrylic terpolymer, about 23 g/m²).

(D) Liner:

Release Coating: Thermal cure silicone (about 2 to about 5 g/m²).

78-pound bleached Kraft Paper.

### EXAMPLE D

Face:

(A) Substrate: 50-pound bleached Kraft paper.

(B) First extruded polymer layer: 11-pound extruded polypropylene.

(C) Adhesive:

Pressure-sensitive adhesive (acrylic terpolymer, about 23 g/m²).

(D) Liner:

Release Coating: Thermal cure silicone (about 2 to about 5 g/m²).

66-pound bleached Kraft paper.

### EXAMPLE E

Face:

(A) Substrate: 61-pound bleached Kraft paper.

(B) First extruded polymer layer: 11-pound extruded high-density polyethylene.

(C) Adhesive:

Pressure-sensitive adhesive (acrylic terpolymer, about 23 g/m²).

(D) Liner:

Release Coating: Thermal cure silicone (about 2 to about 5 g/m²).

18-pound extruded linear low-density polyethylene.

61-pound bleached Kraft paper.

### EXAMPLE F

Face:

(A) Substrate: 50-pound bleached Kraft paper.

(B) First extruded polymer layer: 18-pound extruded linear low-density polyethylene.

(C) Adhesive:

Pressure-sensitive adhesive (acrylic terpolymer, about 23 g/m²).

(D) Liner:

Release Coating: Thermal cure silicone (about 2 to about 5 g/m²).

18-pound extruded linear low-density polyethylene.

50-pound bleached Kraft paper.

### EXAMPLE G

Face:

(A) Substrate: 61-pound bleached Kraft paper.

(B) First extruded polymer layer: 11-pound extruded high-density polyethylene.

(C) Adhesive:

Pressure-sensitive adhesive (acrylic terpolymer, about 23 g/m²).

(D) Liner:

Release Coating: Thermal cure silicone (about 2 to about 5 g/m²).

18-pound extruded high-density polyethylene.

61-pound bleached Kraft paper.

### EXAMPLE H

Face:

(A) Substrate: 61-pound bleached Kraft paper.

(B) First extruded polymer layer: 11-pound extruded high-density polyethylene.

(C) Adhesive:

Pressure-sensitive adhesive (acrylic terpolymer, about 23 g/m²).

(D) Liner:

Release Coating: Electron beam cure silicone (about 2 to about 5 g/m²).

11-pound extruded high-density polyethylene.

61-pound bleached Kraft paper.

### EXAMPLE I

Face:

(A) Substrate: 61-pound bleached Kraft paper.

(B) First extruded polymer layer: 11-pound extruded medium-density polyethylene.

(C) Adhesive:

Pressure-sensitive adhesive (acrylic terpolymer, about 23 g/m²).

(D) Liner:

Release Coating: Thermal cure silicone (about 2 to about 5 g/m²).

11-pound extruded medium-density polyethylene.

50-pound bleached Kraft paper.

### EXAMPLE J

Face:

(A) Substrate: 61-pound off-set graded bleached Kraft paper.

(B) First extruded polymer layer: 18-pound extruded linear low-density polyethylene.

(C) Adhesive:

Pressure-sensitive adhesive (acrylic terpolymer, about 23 g/m²).

(D) Liner:

Release Coating: Thermal cure silicone (about 2 to about 5 g/m²).

10-pound extruded medium density polyethylene.

68-pound Kraft paper.

### EXAMPLE K

Face:

(A) Substrate: 61-pound bleached Kraft paper.

(B) First extruded polymer layer: 11-pound polypropylene.

(C) Adhesive:

Pressure-sensitive adhesive (acrylic terpolymer, about 23 g/m²).

(D) Liner:

Release Coating: Electron beam cure silicone (about 2 to about 5 g/m²).

11-pound extruded polypropylene.

61-pound bleached Kraft paper.

### EXAMPLE L

Face:

(A) Substrate: 61-pound bleached Kraft paper.

(B) First extruded polymer layer: 11-pound polypropylene.

(C) Adhesive:

Pressure-sensitive adhesive (acrylic terpolymer, about 23 g/m²).

(D) Liner:

Release Coating: Thermal cure silicone (about 2 to about 5 g/m²).

1.5 mil extruded polyester.

### EXAMPLE M

Face:

(A) Substrate: 61-pound bleached Kraft paper.

(B) First polymer layer: 1 mil solvent coated, dried urethane.

(C) Adhesive:

Pressure-sensitive adhesive (acrylic terpolymer, about 23 g/m²).

(D) Liner:

Release Coating: Thermal cure silicone (about 2 to about 5 g/m²).

1 mil solvent coated, dried urethane.

61-pound bleached Kraft paper.

### EXAMPLE N

(A) Substrate: 50-pound bleached Kraft paper.

Primer applied to (A) prior to extrusion: polyvinylpyrrolidone (PVP) (about 1 g/m²).

(B) First extruded polymer layer: 18-pound extruded linear extruded low-density polyethylene.

(C) Adhesive: pressure-sensitive adhesive (acrylic terpolymer, about 23 g/m²).

### EXAMPLE O

(A) Substrate: 50-pound bleached Kraft paper.

(B) First extruded polymer layer: 18-pound extruded linear extruded low-density polyethylene.

Primer applied to (B) prior to adhesive: PVP (about 1 g/m²).

(C) Adhesive: pressure-sensitive adhesive (acrylic terpolymer, about 23 g/m²).

### EXAMPLE P

(A) Substrate: 50-pound bleached Kraft paper.

Primer applied to (A) prior to extrusion: PVP (about 1 g/m²).

(B) First extruded polymer layer: 18-pound extruded linear extruded low-density polyethylene.

Primer applied to (B) prior to adhesive: PVP (about 1 g/m²).

(C) Adhesive: pressure-sensitive adhesive (acrylic terpolymer, about 23 g/m²).

### EXAMPLE Q

Face:

(A) Substrate: 61-pound bleached Kraft paper.

Primer applied to (A) prior to extrusion: PVP (about 1 g/m²).

(B) First extruded polymer layer: 11-pound extruded high-density polyethylene.

(C) Adhesive:

Pressure-sensitive adhesive (acrylic terpolymer, about 23 g/m²).

(D) Liner:

Release Coating: Thermal cure silicone (about 2 to about 5 g/m²).

11-pound high-density polyethylene.

61-pound bleached Kraft paper.

### EXAMPLE R

Face:

(A) Substrate: 61-pound bleached Kraft paper.

Primer applied to (A) prior to extrusion: PVP (about 1 g/m²).

(B) First extruded polymer layer: 11-pound extruded high-density polyethylene.

Primer applied to (B) prior to adhesive: PVP (about 1 g/m²).

(C) Adhesive:

Pressure-sensitive adhesive (acrylic terpolymer, about 23 g/m²).

(D) Liner:

Release Coating: Thermal cure silicone (about 2 to about 5 g/m²).

11-pound high-density polyethylene.

61-pound bleached Kraft paper.

### EXAMPLE S

Face:

(A) Substrate: 61-pound bleached Kraft paper.

Primer applied to (A) prior to extrusion: PVP (about 1 g/m²).

(B) First extruded polymer layer: 11-pound extruded high-density polyethylene.

Primer applied to (B) prior to adhesive: PVP (about 1 g/m²).

(C) Adhesive:

Pressure-sensitive adhesive (acrylic terpolymer, about 23 g/m²).

(D) Liner:

Release Coating: Thermal cure silicone (about 2 to about 5 g/m²).

11-pound extruded high-density polyethylene.

Primer applied to Kraft paper prior to extrusion: PVP (about 1 g/m²).

61-pound bleached Kraft paper.

### EXAMPLE T

Face:

(A) Substrate: 61-pound bleached Kraft paper.

(B) First extruded polymer layer: 11-pound polypropylene.

Primer applied to (B) prior to adhesive: PVP (about 1 g/m²).

(C) Adhesive:

Pressure-sensitive adhesive (acrylic terpolymer, about 23 g/m²).

(D) Liner:

Release Coating: Thermal cure silicone (about 2 to about 5 g/m²).

11-pound extruded polypropylene.

Primer applied to Kraft paper prior to extrusion: PVP (about 1 g/m²).

61-pound bleached Kraft paper.

### EXAMPLE U

Poly-reinforced face and poly-reinforced liner, uncoated face with primer on both layers:

facestock: pre-primed—LOPAREX®: grade code 25660 D 73# BL KFT H/0

(A) paper 61# white paper
primer 1AXDC (Loparex proprietary)

(B) polycoat—12# HDPE
Primer: acrylic emulsion

(C) adhesive—removable acrylic emulsion

(D) liner: pre-primed LOPAREX®: grade code 25661 D 73# BL KFT H/0
release coating 4312A thermal cure silicone
polycoat—12# HDPE
primer 1AXDC (Loparex proprietary)
paper 61# white paper

### EXAMPLE V

Poly-reinforced face and poly-reinforced liner, uncoated face and no primer:

facestock: LOPAREX®: grade code 25469 Fine 100+PE 20

(A) paper 61# white paper

(B) polycoat—20 gsm LDPE
Primer acrylic emulsion

(C) adhesive—removable acrylic emulsion

(D) liner: LOPAREX®: grade code 25468 PolyBF 120 gsm
release coating: MR55 thermal cure silicone
polycoat—20 gsm LDPE
paper 61# white paper

### EXAMPLE W

Poly-reinforced face and poly-reinforced liner, coated face with corona treatment instead of primer at poly/paper bond

facestock: LOPAREX®: grade code 25619 D 67# BL C1S H/0

(A) paper 55# C1S white paper

(B) polycoat—12# HDPE
Primer acrylic emulsion

(C) adhesive—removable acrylic emulsion

(D) liner: LOPAREX®: 25621 D 67# BL C1S H/0
release coating X6301 thermal cure silicone
polycoat—12# HDPE
paper 55# C1S white paper

### EXAMPLE X

Poly-reinforced face and standard liner:

facestock: LOPAREX®: grade code 25660 D 73# BL KFT H/0

A) paper 61# white fine paper
primer 1AXDC (Loparex proprietary)

(B) polycoat—12# HDPE

(C) adhesive—permanent emulsion acrylic

(D) liner: LOPAREX® 1—50BMFC 7430
release coating 7430 thermal cure silicone
paper 50# machine finish

The composites of the present invention exhibit improved strength, thermal stability, dimensional stability, tear-resistance and moisture-resistance. The composites also exhibit reduced shrinkage and reduced curling subjected to laser printing or pass through copying machines and in use. In particular, the composites of the present invention exhibit reduced curling when used under adverse conditions such as when used in freezers such as freezers of retail grocery stores.

The ability of the composites of the present invention to resist curling in both room temperature and at 0° F. environments is determined and demonstrated in the following Label Curling Test.

Sample Preparation:

(1) From each of the labels to be tested, one 3-inch by 4-inch samples is die-cut in the machine direction, and this sample is labeled “machine direction” with an arrow indicating the machine direction.

(2) With the face side of the machine direction sample (M.D.) down, a utility knife and ruler is used to score a line one-half-inch from the edge, across the 3-inch side of the sample and through the “liner” only.

(3) Remove or score strip the ½-inch section of liner and apply one sample to the center of a galvanized steel panel.

(4) At this time, each steel panel should have a sample for a machine direction (M.D.).

Procedure:

(1) An initial measurement of curl is made on each of the samples from an “end on view” at the left, center and right positions of the machine direction (M.D.).

(2) Place one panel in a laboratory freezer at 0° F. (±5° F.).

(3) After a given period (24 hours) in the freezer, the panel is removed from the freezer and measurements are taken immediately from an “end on view” at the left, center and right positions of the machine direction (M.D.).

(4) When the measurements are completed on the freezer samples, the samples are allowed to thaw at room temperature for about 60 minutes, and the measurements of the curl are repeated.

(5) The freezer samples are then returned to the freezer for an additional period, whereupon the samples are removed from the freezer and the curl from an “end on view” at the left, center and right positions of each of the samples on the panel is again measured.

(6) After allowing the samples to thaw at room temperature for one hour, the measurements of the curl are repeated and recorded.

(7) The freeze (5) and thaw (6) cycles may be repeated as desired.

The composites which are prepared in accordance with the present invention and which have been described above exhibit improved strength, thermal stability, dimensional stability, tear-resistance, solvent-resistance and moisture-resistance. An additional significant property of the composites of the present invention is their ability to lay flat and remain in a flat condition on aging even when subjected to extreme environmental conditions such as high and low humidity, high and low temperatures, etc. The surface characteristics of the composites of the invention, and in particular, the characteristics of the paper on the outer surfaces of the composite renders the construction laser imageable with or without the application of primers, inks and over-varnishes. The images which are deposited on the paper surfaces are bright and exhibit good toner anchorage.

While the invention has been explained in relation to certain of its embodiments, it is to be understood that various modifications thereof will become apparent to those skilled in the art upon reading the specification. Therefore, it is to be understood that the invention disclosed herein is intended to cover such modifications as fall within the scope of the appended claims.

1. A composite comprising
(A) a first layer of paper having a printable upper surface and a lower surface, the printable upper surface forming a topmost surface of the composite;
(B) a first extruded polymer layer having an upper surface joined to the lower surface of the first layer of paper and having a lower surface; and
(C) an adhesive layer on the lower surface of the first extruded polymer layer.

2. The composite of claim 1 wherein the extruded polymer layer comprises a high-density polyethylene having a density of from about 0.940 to about 0.965, a medium-density polyethylene having a density of from about 0.925 to about 0.940, a low-density polyethylene having a density of from about 0.910 to about 0.925, a polypropylene, or a mixture or blend thereof.

3. The composite of claim 1 further comprising at least one primer layer between the paper and the first extruded polymer layer and/or between the first extruded polymer layer and the adhesive.

4. The composite of claim 1 further comprising
(D) a release-coated liner having a topmost surface and a bottommost surface and comprising a second layer of paper or a second polymer layer having an upper surface and a lower surface and a release coating having an upper surface and a lower surface,
wherein the upper surface of the release coating forms the topmost surface of the release-coated liner and is in contact with the adhesive layer, and the lower surface of the second layer of paper or second polymer layer forms the bottommost surface of the release-coated liner.

5. The composite of claim 4 wherein the release coating is directly on the upper surface of the second layer of paper or the second polymer layer.

6. The composite of claim 4 wherein the release coating comprises a silicone.

7. The composite of claim 4 wherein the bottommost surface of the release-coated liner is printable.

8. The composite of claim 4 wherein the release-coated liner comprises both the second layer of paper and the second polymer layer, the second polymer layer having its upper surface joined to the release coating and its lower surface joined to the upper surface of the second layer of paper.

9. The composite of claim 8 wherein the second polymer layer comprises a high-density polyethylene having a density of from about 0.940 to about 0.965, a medium-density polyethylene having a density of from about 0.925 to about 0.940, a low-density polyethylene having a density of from about 0.910 to about 0.925, a polypropylene, or a mixture or blend thereof.

10. The composite of claim 8 further comprising a primer layer between the second polymer layer and the second layer of paper.

11. The composite of claim 8 wherein the second polymer layer is extruded.

12. A composite comprising
(A) a first layer of paper having a printable upper surface and a lower surface, the printable upper surface forming a topmost surface of the composite;
(B) an extruded polyolefin layer having an upper surface joined to the lower surface of the first layer of paper and having a lower surface;
(C) an adhesive on the lower surface of the extruded polyolefin layer; and
(D) a release-coated liner having a topmost surface and a bottommost surface and comprising a second layer of paper having an upper surface and a lower surface, a second polyolefin layer having an upper surface and a lower surface and a release coating having an upper surface and a lower surface, wherein the upper surface of the release coating forms the topmost surface of the release-coated liner and is in contact with the adhesive layer, the upper surface of the second polyolefin layer is joined to the lower surface of the release coating, and the lower surface of the second polyolefin layer is joined to the upper surface of the second layer of paper, and the lower surface of the second layer of paper forms the bottommost surface of the release-coated liner.

13. The composite of claim 12 wherein the extruded polyolefin layer comprises a high-density polyethylene having a density of from about 0.940 to about 0.965, a medium-density polyethylene having a density of from about 0.925 to about 0.940, a low-density polyethylene having a density of from about 0.910 to about 0.925, a polypropylene, or a mixture or blend thereof.

14. The composite of claim 12 wherein the second polyolefin layer comprises a high-density polyethylene having a density of from about 0.940 to about 0.965, a medium-density polyethylene having a density of from about 0.925 to about 0.940, a low-density polyethylene having a density of from about 0.910 to about 0.925, a polypropylene, or a mixture or blend thereof.

15. The composite of claim 12 further comprising at least one primer layer between the first layer of paper and the extruded polyolefin layer, and/or between the extruded polyolefin layer and the adhesive layer, and/or between the second polyolefin layer and the second paper layer.

16. The composite of claim 12 wherein the release coating comprises a silicone.

17. The composite of claim 12 wherein the bottommost surface of the release-coated liner is printable.

18. The composite of claim 12 wherein the second polymer layer is extruded.

19. A composite comprising
(A) a first layer of paper having a printable upper surface and a lower surface, the printable upper surface forming a topmost surface of the composite;
(B) an extruded polyolefin layer having an upper surface joined to the lower surface of the first layer of paper and having a lower surface;
(C) an adhesive on the lower surface of the extruded polyolefin layer;
(D) a release-coated liner having a topmost surface and a bottommost surface and comprising a second layer of paper having an upper surface and a lower surface, a second extruded polyolefin layer having an upper surface and a lower surface and a release coating having an upper surface and a lower surface, wherein the upper surface of the release coating forms the topmost surface of the release-coated liner and is in contact with the adhesive layer, the upper surface of the second extruded polyolefin layer is joined to the lower surface of the release coating, and the lower surface of the second extruded polyolefin layer is joined to the upper surface of the second layer of paper, and the lower surface of the second layer of paper forms the bottommost surface of the release-coated liner; and
at least two primer layers at least one each between the first layer of paper and the first extruded polyolefin layer, and/or between the first extruded polyolefin layer and the adhesive layer, and/or between the second extruded polyolefin layer and the second paper layer.

20. The composite of claim 19 wherein the extruded polymer layer comprises a high-density polyethylene having a density of from about 0.940 to about 0.965, a medium-density polyethylene having a density of from about 0.925 to about 0.940, a low-density polyethylene having a density of from about 0.910 to about 0.925, a polypropylene, or a mixture or blend thereof.

21. The composite of claim 19 wherein the second extruded polyolefin layer comprises a high-density polyethylene having a density of from about 0.940 to about 0.965, a medium-density polyethylene having a density of from about 0.925 to about 0.940, a low-density polyethylene having a density of from about 0.910 to about 0.925, a polypropylene, or a mixture or blend thereof.

22. The composite of claim 19 wherein the release coating comprises a silicone.

23. The composite of claim 19 wherein the bottommost surface of the release-coated liner is printable.

24. The composite of claim 19, wherein a first primer layer is between the first layer of paper and the first extruded polyolefin layer, forming first laminate, a second primer layer is between the second extruded polyolefin layer and the second layer of paper, forming a second laminate, and the first laminate is substantially the same as the second laminate.

25. A die-cut label comprising the composite of claim 1.

26. A die-cut label comprising the composite of claim 2.

27. A die-cut label comprising the composite of claim 12.

28. A die-cut label comprising the composite of claim 19.
